(19) United States
(12) Patent Application Publication
(10) Pub. No.: US 2026/0197238 A1
(43) Pub. Date: Jul. 9, 2026

(54) REBALANCING AN EVENT STREAMING PLATFORM

(71) Applicant: INTERNATIONAL BUSINESS MACHINES CORPORATION, Armonk, NY (US)

(72) Inventors: Xin Xin Dong, Beijing (CN); Mai Zeng, BEIJING (CN); MING QIAO SHANG GUAN, BEIJING (CN); Wei Song, Beijing (CN); Peng Hui Jiang, Beijing (CN); Wen Zhong Liu, Beijing (CN)

(21) Appl. No.: 19/012,994

(22) Filed: Jan. 8, 2025

(51) Int. Cl. H04L 41/0893; H04L 41/147; H04L 41/16

(52) U.S. Cl. CPC H04L 41/0893; H04L 41/147; H04L 41/16

(57) ABSTRACT

Embodiments collect a real-time data of a broker; predict a broker score based on a trained broker bottleneck prediction model; predict a final topic partition health prediction based on a trained topic partition model; determine that a partition leader needs to be changed based on the predicted final topic partition health prediction being abnormal; and adjust the partition leader to a healthy broker based on the determination.

### BACKGROUND

Aspects of the present invention relate generally to a system and a method for rebalancing an event streaming platform.

An event streaming platform comprises servers and clients. In particular, the event streaming platform includes producers which are client applications that publish events to the event streaming platform. Further, the event streaming platform includes consumers which subscribe to the published events. The published events are stored in topics, which are partitioned into a number of buckets such that each topic partition is stored in a different broker.

### SUMMARY

In a first aspect of the invention, there is a computer-implemented method including: collecting, by a processor set, real-time data of a broker which manages data flow in a cluster; predicting, by the processor set, a broker score based on a trained broker bottleneck prediction model, the trained broker bottleneck prediction model is trained with the real-time data of the broker; predicting, by the processor set, a final topic partition health prediction based on a trained topic partition model, the trained topic partition model is trained with the predicted broker score; determining, by the processor set, that a partition leader is changing based on the predicted final topic partition health prediction being abnormal; and adjusting, by the processor set, the partition leader to a healthy broker based on the determination.

In another aspect of the invention, there is a computer program product including one or more computer readable storage media and program instructions stored on the one or more computer readable storage media to perform operations including: collecting real-time data of a broker which manages data flow in a cluster; predicting a broker score based on a trained broker bottleneck prediction model, the trained broker bottleneck prediction model is trained with the real-time data of the broker; predicting a final topic partition health prediction based on a trained topic partition model, the trained topic partition model is trained with the predicted broker score; determining that a partition leader is changing based on the predicted final topic partition health prediction being abnormal; and adjusting the partition leader to a healthy broker based on the determination.

In another aspect of the invention, there is a system including a processor set, one or more computer readable storage media, and program instructions stored on the one or more computer readable storage media to cause the processor set to perform operations including: collecting real-time data of a broker which manages data flow in a cluster; predicting a broker score based on a trained broker bottleneck prediction model, the trained broker bottleneck prediction model is trained with the real-time data of the broker; predicting a final topic partition health prediction based on a trained topic partition model, the trained topic partition model is trained with the predicted broker score; determining that a partition leader is changing based on the predicted final topic partition health prediction being abnormal; scanning a plurality of brokers to determine a healthy broker; adjusting the partition leader to the healthy broker based on the determination; and starting a previous partition leader as a follower.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows a block diagram of the exemplary environment in accordance with aspects of the present invention.

FIG. 4 shows a first table in accordance with aspects of the present invention.

FIG. 5 shows a second table in accordance with aspects of the present invention.

FIG. 6 shows a topic partition baseline graph in accordance with aspects of the present invention.

FIG. 7 shows a block diagram of validation steps in accordance with aspects of the present invention.

FIG. 8 shows a block diagram of a partition leader adjustment in accordance with aspects of the present invention.

FIG. 9 shows a flowchart of an exemplary method in accordance with aspects of the present invention.

FIG. 10 shows a flowchart of an exemplary method in accordance with aspects of the present invention.

FIG. 11 shows a flowchart of an exemplary method in accordance with aspects of the present invention.

FIG. 12 shows a block diagram of the exemplary environment in accordance with aspects of the present invention.

### DETAILED DESCRIPTION

Aspects of the present invention relate generally to a system and a method for rebalancing an event streaming platform. Embodiments of the present invention provide a system, a computer program product, and a computer-implemented method for adjusting a topic partition intelligently in a cluster of the event streaming platform. In particular, aspects of the present invention provide a system, a computer program product, and a computer-implemented method to keep a broker and topic healthy during a lifetime. In further aspects of the present invention, the computer-implemented method intelligently adjusts a partition to reduce latency. Embodiments of the present invention predict broker and topic health intelligently. In further embodiments of the present invention, the event streaming platform is Kafka™. However, embodiments are not limited to Kafka™ such that embodiments can be utilized with any event streaming platform technology.

Embodiments of the present invention also arrange a topic to the partitions intelligently. Embodiments of the present invention determine broker health intelligently. Embodiments of the present invention dynamically change a broker and a topic partition leader based on a prediction of broker health and topic partition latency. For example, a computer-implemented method includes: predicting broker health based on historical data collected by a data collection module; predicting a topic-partition delay based on the historical data and predicted broker health; changing and removing a topic partition leader in response to a broker being unhealthy based on the topic-partition delay; starting the changed and removed topic partition leader as a follower in response to the broker being healthy; and generating and executing a switch script to change the follower of the changed and removed topic partition leader to a leader again after the broker has become healthy. Accordingly, implementations of the present invention provide dynamic adjustments to topic partitions to alleviate resource bottlenecks.

Conventional event streaming platforms have data accumulation that occurs in response to resource bottlenecks on a server which runs a broker. Further, conventional event streaming platforms systems are not able to dynamically adjust to the resource bottlenecks because topics are partitioned at a time of topic creation. In other words, conventional event streaming platforms ensure that a number of partitions are evenly distributed across disks during the time of topic creation, but do not perform real-time monitoring of the actual space occupied by each topic partition. Accordingly, conventional systems have limitations which prevent dynamic adjustment of topic partitions and prevent relief of the resource bottlenecks. In contrast, embodiments of the present invention provide a computer-implemented method, a system, and a computer program product for predicting topic partition health utilizing an integrated intelligent model. Further, aspects of the present invention dynamically and intelligently change a topic partition leader in real-time based on a final predicted topic partition health to address resource bottlenecks.

Embodiments of the present invention include a system, method, and computer program product for providing a dynamic adjustment of topic partitions to reduce data latency. Accordingly, implementations of the present invention provide an improvement (i.e., technical solution) to a problem arising in the technical field of event streaming platforms. In particular, embodiments of the present invention intelligently adjust topic partitions based on a predicted topic partition health. Further, embodiments of the present invention determine the predicted topic partition health based on historical and real-time data.

Implementations of the present invention are necessarily rooted in computer technology. For example, the steps of predicting a broker score based on a trained broker bottleneck prediction model; predicting a final topic partition health prediction based on a trained topic partition model; and adjusting the partition leader to a healthy broker cannot be performed in the human mind (or with pen and paper). Predicting a broker score based on a trained broker bottleneck prediction model, predicting a final topic partition health prediction based on a trained topic partition model, and adjusting the partition leader to a healthy broker in real-time is, by definition, performed by a computer and cannot be performed in the human mind (or with a pen and paper) due to the complexity and amounts of calculations involved in the rebalancing server. In further embodiments, the steps of predicting a broker score based on a trained broker bottleneck prediction model; predicting a final topic partition health prediction based on a trained topic partition model; and adjusting the partition leader to a healthy broker are also rooted in computer technology and cannot be performed in the human mind (or with pen and paper). In further embodiments, the steps of training a trained broker bottleneck prediction model using historical data of the broker and the real-time data of the broker by utilizing a first machine learning (ML) algorithm and training a trained topic partition model using a delay for a partition, message count, and message type by utilizing a second machine learning (ML) algorithm are also necessarily rooted in computer technology.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as rebalancing code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

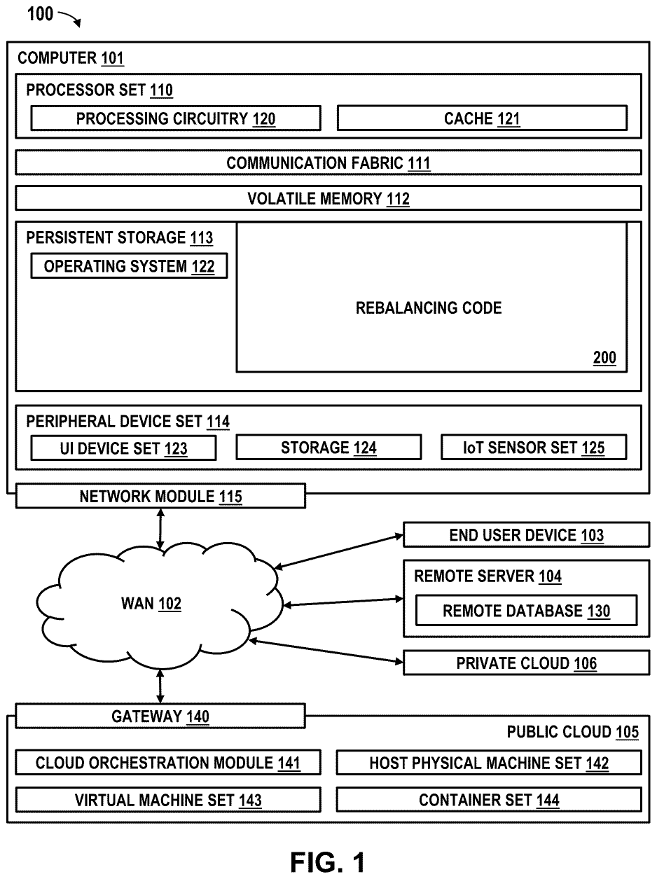

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

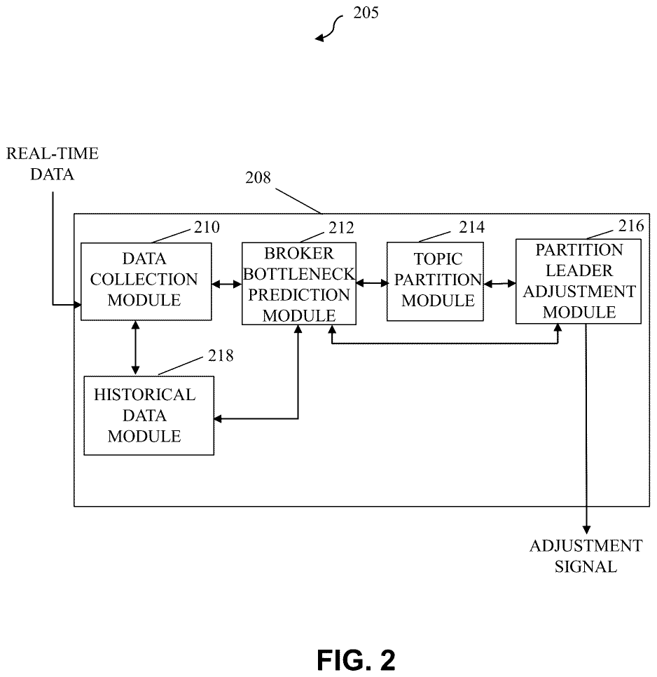

FIG. 2 shows a block diagram of an exemplary environment 205 in accordance with aspects of the present invention. In embodiments, the environment 205 includes a rebalancing server 208, which may comprise one or more instances of the computer 101 of FIG. 1. In other examples, the rebalancing server 208 comprises one or more virtual machines or one or more containers running on one or more instances of the computer 101 of FIG. 1.

In embodiments, the rebalancing server 208 of FIG. 2 comprises a data collection module 210, a broker bottleneck prediction module 212, a topic partition module 214, a partition leader adjustment module 216, and a historical data module 218, each of which may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the present invention as described herein. These modules of the code of block 200 are executable by the processing circuitry 120 of FIG. 1 to perform the inventive methods as described herein. The rebalancing server 208 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In embodiments, the data collection module 210 collects real-time data of a broker from an external system. In further embodiments, the external system comprises an external application which collects real-time data of the broker. In embodiments, a broker comprises a server which manages data flow between a consumer and a producer in a cluster. In further embodiments, a producer comprises an application in which data is written into and arranged in topics. In further embodiments, a consumer comprises an application that reads data from the topics. In particular, topics refer to a category in which data is stored and published. In aspects of the present invention, topic partitions represent a breaking up of a topic in multiple partitions with each topic partition having a corresponding log file. In aspects of the present invention, the real-time data of the broker comprise at least one of system layer data including broker input/output throughput, central processing unit (CPU) usage, etc., and cluster layer data including partition number, definition rules for a partition for every topic, a consumer number, and a delay. In an example, the data collection module 210 formats continuous data to different classes according to a profile. In further embodiments, the data collection module 210 sends the real-time data of the broker to the broker bottleneck prediction module 212 and the historical data module 218 for storage and model training. The historical data module 218 stores the real-time data of the broker as historical data of the broker with a timestamp corresponding to when the real-time data of the broker was captured by the data collection module 210. Accordingly, the broker bottleneck prediction module 212 receives the historical data of the broker with the timestamp in response to the broker bottleneck prediction module 212 training a broker bottleneck prediction model.

In embodiments, the broker bottleneck prediction module 212 trains the broker bottleneck prediction model using the historical data of the broker and the real-time data of the broker by utilizing a first machine learning algorithm. In aspects of the present invention, the first machine learning algorithm comprises a long short-term memory (LSTM) algorithm. In further embodiments, the broker bottleneck prediction module 212 predicts a broker score for the next few seconds based on the trained broker bottleneck prediction model. In further aspects of the present invention, the historical data of the broker comprises CPU usage, storage usage, and input/output (IO) delay. In further embodiments, the broker bottleneck prediction module 212 determines that a broker is healthy in response to the predicted broker score being above a predetermined broker score threshold. The broker bottleneck prediction module 212 sends the predicted broker score and the historical data of the broker to the topic partition module 214.

In further embodiments, the topic partition module 214 receives the historical data of the broker and the predicted broker score from the broker bottleneck prediction module 212. In aspects of the present invention, the topic partition module 214 extracts producer-consumer delay for each topic based on the historical data of the broker and creates a topic partition baseline graph with a topic partition on the x axis and delay for each topic partition on the y axis. In further aspects of the present invention, the topic partition module 214 trains a topic partition model using the delay for the topic partition, message count, and message type by utilizing a second machine learning algorithm. In embodiments, the second machine learning algorithm comprises the LSTM algorithm. In further embodiments, the topic partition model 214 predicts a final topic partition health prediction based on the trained topic partition model. In embodiments, the final topic partition health prediction is 0 if normal health occurs and the final topic partition health prediction is 1 if abnormal health occurs. However, embodiments are not limited to the above example such that the final topic partition health prediction can be 1 if normal health occurs and the final topic partition health prediction can be 0 if abnormal health occurs. The topic partition model 214 sends the final topic partition health prediction to the partition leader adjustment module 216.

In aspects of the present invention, the partition leader adjustment module 216 receives the final topic partition health prediction and determines whether to adjust a partition leader. In an example, the partition leader adjustment module 216 does not adjust the partition leader in response to the final topic partition health prediction being 0 (e.g., normal health). In this scenario, the partition leader adjustment module 216 directs the rebalancing server 208 to not adjust the partition leader and then goes back to performing collection of real-time data in the data collection module 210.

In embodiments, the partition leader adjustment module 216 adjusts the partition leader in response to the final topic partition health prediction being 1 (e.g., abnormal health). In this scenario, the partition leader adjustment module 216 outputs an adjustment signal to the external application to indicate that the partition leader is going to be adjusted. The partition leader adjustment module 216 adjusts the partition leader to a healthy broker. In embodiments, the adjustment signal is sent to the external application to trigger the adjustment of the partition leader. However, embodiments are not limited to this example such that the adjustment signal is generated within the rebalancing server 208. In further embodiments, the partition leader adjustment module 216 scans a partition distribution of all brokers to predict the broker score of all the brokers using the broker bottleneck prediction module 212. In aspects of the present invention, the partition leader adjust module 216 scans the partition distribution by iterating through each partition of a topic to observe message keys and analyzing how the message keys are distributed across different partitions. The partition leader adjustment module 216 selects a broker with a highest broker score as a new partition leader. The partition leader adjustment module 216 performs a high water mark (HWM) policy on all the partitions to determine an offset of a last message that has been successfully replicated to all replicas of a partition. In further embodiments, the HWM policy ensures that the offset of the last message that has been successfully replicated to all replicas of the partition marks a point beyond which the consumer is able to safely read messages to ensure that no data is lost due to potential broker failures. The HWM is maintained by a leader replica of a partition. The partition leader adjustment module 216 runs a script to adjust the partition leader to the healthy broker. The partition leader adjustment module 216 drops the previous partition leader. In further embodiments, the partition leader comprises a primary broker which is responsible for handling all read and write operations for a specific partition within a topic. In aspects of the present invention, a follower comprises a replica broker which passively replicates data from the partition leader to ensure data redundancy and high availability in case the partition leader fails. The partition leader adjustment module 216 then re-scans the partition distribution of all the brokers to predict the broker score of all of the broker using the broker bottleneck prediction module 212. In an example, the partition leader adjustment module 216 continues to re-scan the partition distribution of all the brokers in response to determining at least one broker is not healthy. In another example, the partition leader adjustment module 216 starts the previous partition leader as a follower in response to determining that all of the brokers are healthy. The partition leader adjustment module 216 synchronizes messages with the new partition leader. The partition leader adjustment module 216 switches the partition leader to the previous partition leader in response to determining that the previous partition leader is healthy.

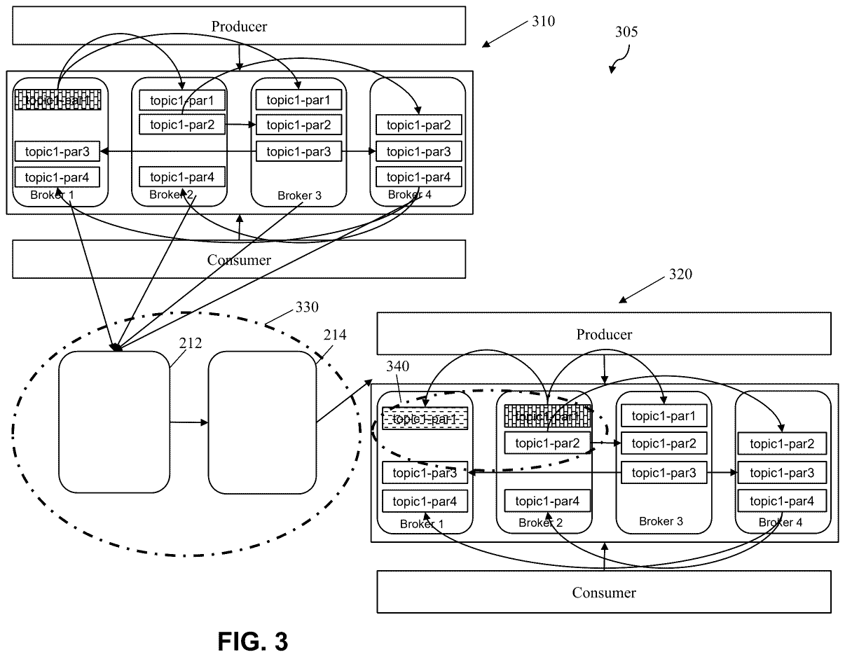

FIG. 3 shows a block diagram of the exemplary environment in accordance with aspects of the present invention. In FIG. 3, the block diagram 305 includes a first architecture 310 with a producer, a consumer, and brokers 1, 2, 3, and 4. In embodiments, the block diagram 305 also includes an adjustment block 330 including the broker bottleneck prediction module 212 and the topic partition module 214. In further embodiments, the adjustment block 330 utilizes the broker bottleneck prediction module 212 and the topic partition module 214 as described above with respect to FIG. 2 to adjust the first architecture 310 to a second architecture 320. In particular, the second architecture 320 includes an adjusted topic partition block 340 in which the topic-partition 1 of broker 1 (i.e., topic1-par1 of the broker 1) is a new healthy broker that is the new partition leader after adjusting the first architecture 310. In further embodiments, the adjusted topic partition block 340 includes the previous partition leader which has been adjusted to be a follower in the topic-partition 1 of broker 2 (i.e., topic1-part1 of the broker 2).

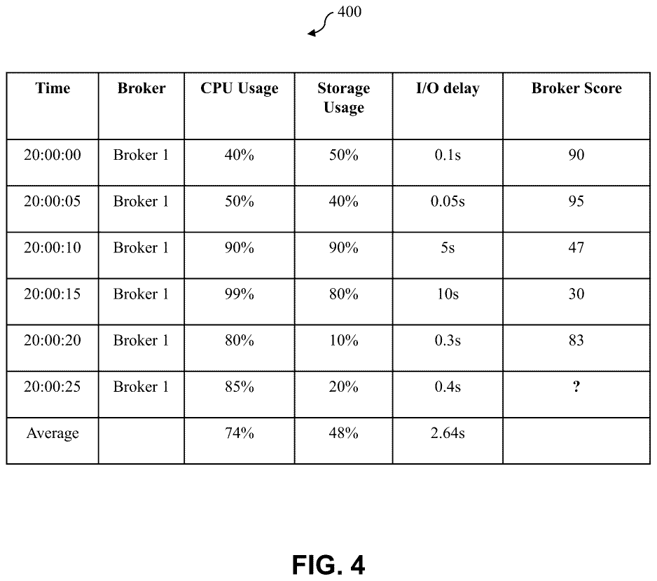

FIG. 4 shows a first table in accordance with aspects of the present invention. In FIG. 4, the first table 400 is a table of the broker bottleneck prediction module 212 with respect to FIG. 2. In particular, the first table 400 includes columns with respect to time, broker, CPU usage, storage usage, input/output (IO) delay, and a broker score. In the first table 400, the broker bottleneck partition module 212 predicts the broker score based on the trained broker bottleneck prediction model. In further embodiments, the trained broker bottleneck prediction model is trained on the CPU usage, the storage usage, and the IO delay of the historical data. In further embodiments, the broker bottleneck prediction module 212 determines that a broker is healthy in response to the predicted broker score being above a predetermined broker score threshold.

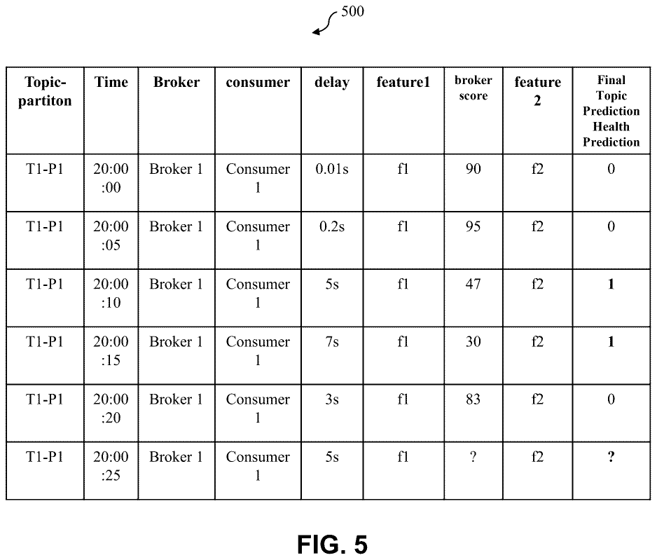

FIG. 5 shows a second table in accordance with aspects of the present invention. In FIG. 5, the second table 500 is a table of the topic partition module 214 with respect to FIG. 2. In particular, the second table 500 includes columns with respect to topic-partition, time, broker, consumer, delay, feature 1, feature 2, predicted broker score, and final topic partition health prediction. In the second table 500, the topic partition module 214 predicts the final topic partition health prediction based on the trained topic partition model. In further embodiments, the trained topic partition model is trained on the delay for the topic partition, message count, and message type of the historical data.

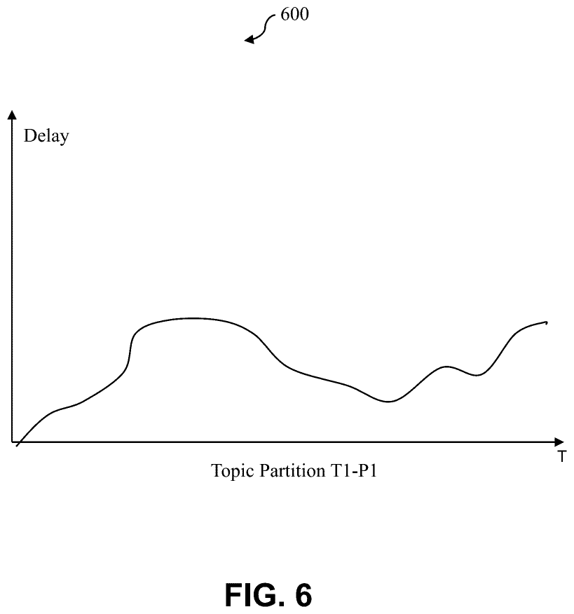

FIG. 6 shows a topic partition baseline graph in accordance with aspects of the present invention. In FIG. 6, the topic partition baseline graph 600 includes a topic partition on the x axis and delay for each topic partition on the y axis.

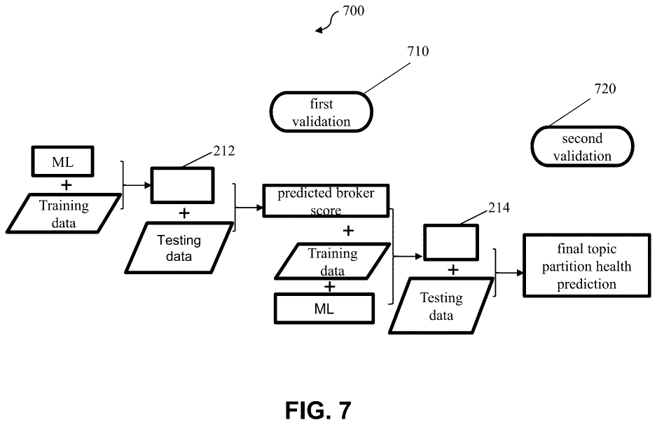

FIG. 7 shows a block diagram of validation steps in accordance with aspects of the present invention. In embodiments of the present invention, the block diagram 700 divides real-time data of the broker and historical data into testing data and training data. As shown in the block diagram 700, a first machine learning (ML) algorithm utilizes the training data to train the broker bottleneck prediction model and sends the trained broker bottleneck prediction model to the broker bottleneck prediction module 212. Then, the broker bottleneck prediction module 212 uses the trained broker bottleneck prediction model and the testing data to predict the broker score for the next few seconds based on the trained broker bottleneck prediction model. At this time, the rebalancing server 208 performs a first validation 710 on the predicted broker score to check whether the predicted broker score has an accurate prediction. In embodiments, the rebalancing server 208 uses an actual broker score of real-time data to determine whether the predicated broker score has an accurate prediction. In further embodiments of the block diagram 700, a second ML algorithm utilizes the training data and the predicted broker score to train a topic partition model and sends the trained topic partition model to the topic partition module 214. The topic partition module 214 uses the trained topic partition model and the testing data to predict the final topic partition health prediction. At this time, the rebalancing server 208 performs a second validation 720 on the predicted broker score to check whether the final topic partition health prediction has an accurate prediction. In embodiments, the rebalancing server 208 uses the actual broker health of a broker to determine whether the final topic partition health prediction has an accurate prediction.

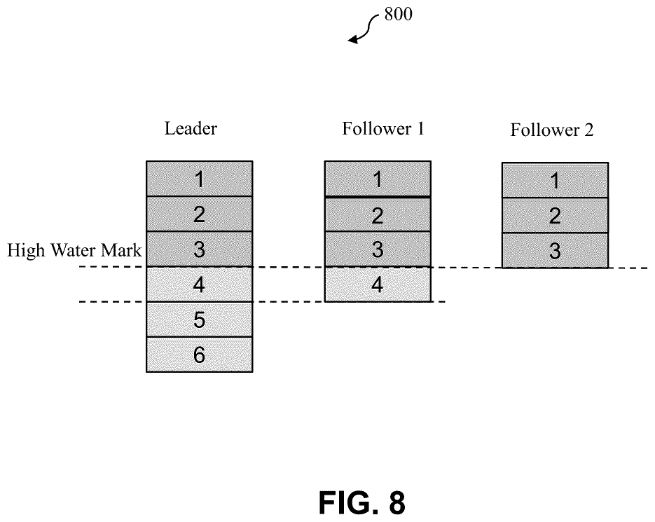

FIG. 8 shows a block diagram of a partition leader adjustment in accordance with aspects of the present invention. In the block diagram 800, the partition leader adjustment module 216 determines that the leader is abnormal as indicated by the final topic partition health prediction and that the leader has encountered resource bottlenecks (e.g., messages 4, 5, and 6 of the follower). The partition leader adjustment 216 then scans the partition distribution on all of the brokers and determines that follower 2 is healthy and has a highest broker score of the brokers (i.e., follower 2 has a broker score which is above a predetermined broker score threshold and is the highest broker score). The partition leader adjustment 216 selects follower 2 as new leader. The partition leader adjustment 216 performs a high water mark (HWM) policy on all the partitions to determine an offset of a last message (e.g., message 3 in this scenario) that has been successfully replicated to all replicas of a partition. In other words, the partition leader adjustment 216 determines that message 3 is the last message that has been successfully replicated to all replicas of the partition. The partition leader adjustment 216 runs a script to adjust the partition leader to the healthy broker (i.e., follower 2). Thus, the partition leader adjustment 216 changes the partition leader to follower 2.

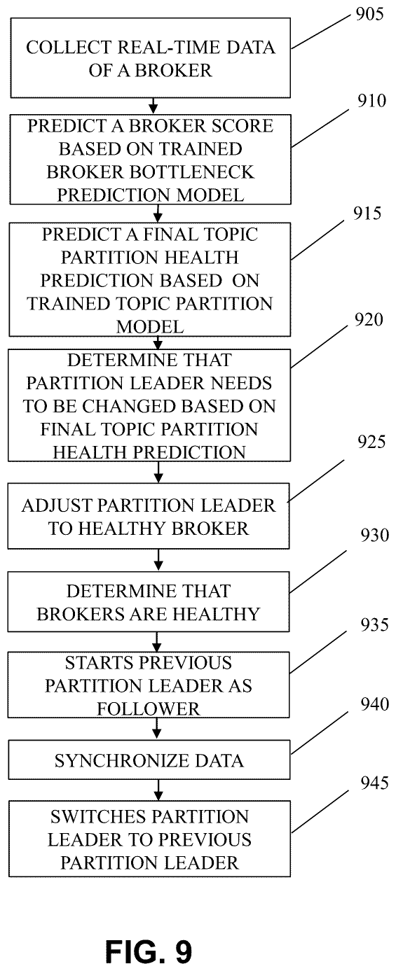

FIG. 9 shows a flowchart of an exemplary method in accordance with aspects of the present invention. Steps of the method may be carried out as operations in the environment 205 of FIG. 2 and are described with reference to elements depicted in FIG. 2.

At step 905, the system collects, at the data collection module 210, real-time data of a broker from an external system. In embodiments and as described with FIG. 2, the data collection module 210 sends the real-time data of the broker to the broker bottleneck prediction module 212 and the historical data module 218. At step 910, the system predicts, at the broker bottleneck prediction module 212, a broker score based on the trained broker bottleneck prediction model. In embodiments and as described with FIG. 2, the broker bottleneck prediction model is trained with the historical data of the broker and the real-time data of the broker using a first ML algorithm.

At step 915, the system predicts, at the topic partition module 214, a final topic partition health prediction based on a trained topic partition model. Also, in embodiments and as described with FIG. 2, the topic partition model is trained with the delay for the topic partition, message count, and message type by using a second ML algorithm.

At step 920, the system determines, at the partition leader adjustment module 216, that the partition leader needs to be changed based on the final topic partition health prediction. In embodiments and as described with FIG. 2, the partition leader adjustment module 216 determines that the partition leader needs to be changed based on the final topic partition health prediction being abnormal. At step 925, the system adjusts, at the partition leader adjustment module 216, the partition leader to a healthy broker in response to the final topic partition health prediction indicating abnormal health. In embodiments and as described with FIG. 2, the partition leader adjustment module 216 scans a partition distribution of all brokers to predict the broker score and selecting a broker with a highest broker score as a new partition leader (i.e., the healthy broker).

At step 930, the system determines, at the partition leader adjustment module 216, that a plurality of brokers are healthy. In embodiments and as described with FIG. 2, the partition leader adjustment module 216 determines that the plurality of brokers are healthy in response to the plurality of brokers having a broker score above a predetermined broker score threshold. At step 935, the system starts, at the partition leader adjustment module 216, a previous partition leader as a follower.

At step 940, the system synchronizes, at the partition leader adjustment module 216, messages with a new partition leader. At step 945, the system switches, at the partition leader adjustment module 216, the partition leader to the previous partition leader.

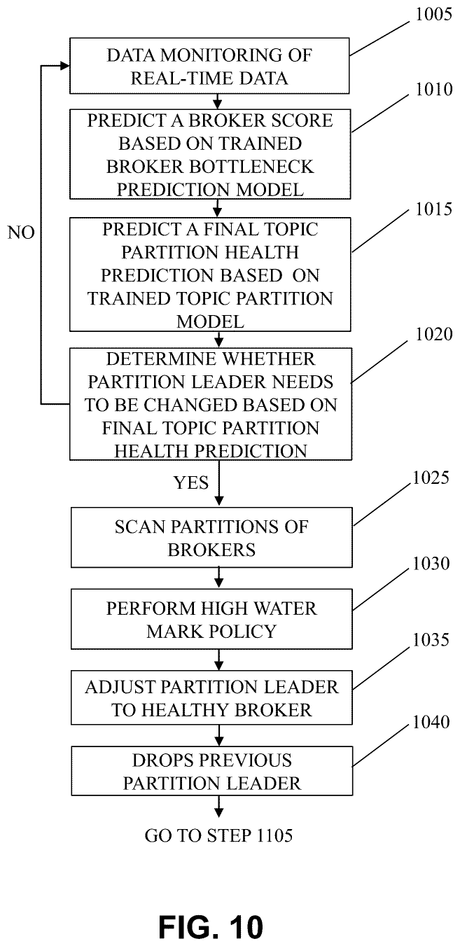

FIG. 10 shows a flowchart of an exemplary method in accordance with aspects of the present invention. Steps of the method may be carried out as operations in the environment 205 of FIG. 2 and are described with reference to elements depicted in FIG. 2.

At step 1005, the system performs, at the data collection module 210, data monitoring of real-time data of a broker from an external system. In embodiments and as described with FIG. 2, the data collection module 210 sends the real-time data of the broker to the broker bottleneck prediction module 212 and the historical data module 218. At step 1010, the system predicts, at the broker bottleneck prediction module 212, a broker score based on the trained broker bottleneck prediction model. In embodiments and as described with FIG. 2, the broker bottleneck prediction model is trained with the historical data of the broker and the real-time data of the broker using a first ML algorithm.

At step 1015, the system predicts, at the topic partition module 214, a final topic partition health prediction based on a trained topic partition model. Also, in embodiments and as described with FIG. 2, the topic partition model is trained with the delay for the topic partition, message count, and message type by using a second ML algorithm.

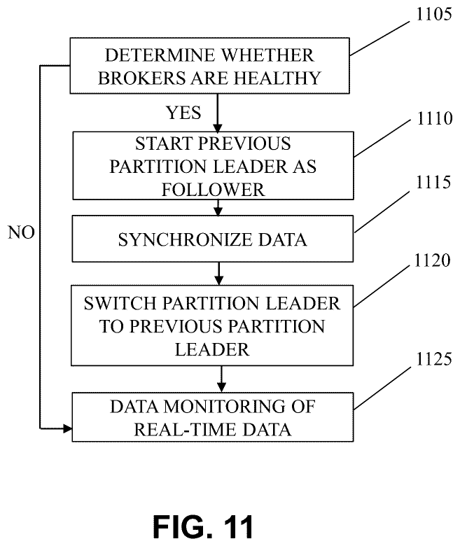

At step 1020, the system determines, at the partition leader adjustment module 216, whether the partition leader needs to be changed based on the final topic partition health prediction. In embodiments and as described with FIG. 2, the partition leader adjustment module 216 determines that the partition leader needs to be changed based on the final topic partition health prediction being abnormal (i.e., YES at step 1020). In this scenario, the operations move to step 1025. The partition leader adjustment module 216 determines that the partition leader does not need to be changed based on the final topic partition health prediction being normal (i.e., NO at step 1020). In this scenario, the operations return to step 1005. At step 1025, the system scans, at the partition leader adjustment module 216, partitions of brokers to determine a healthy broker. In embodiments and as described in FIG. 2, the partition leader adjustment module 216 determines the healthy broker by selecting a broker with a highest broker score. At step 1030, the system performs, at the partition leader adjustment module 216, a high water mark (HWM) policy on all of the partitions to determine an offset of a last message that has been successfully replicated to all replicas of a partition. At step 1035, the system adjusts, at the partition leader adjustment module 216, the partition leader to a healthy broker in response to the final topic partition health prediction indicating abnormal health. At step 1040, the system drops, at the partition leader adjustment module 216, the previous partition leader. The operations them move to step 1105 in FIG. 11.

FIG. 11 shows a flowchart of an exemplary method in accordance with aspects of the present invention. Steps of the method may be carried out as operations in the environment 205 of FIG. 2 and are described with reference to elements depicted in FIG. 2.

At step 1105, the system determines, at the partition leader adjustment module 216, whether the plurality of brokers are healthy. In embodiments and as described with FIG. 2, the partition leader adjustment module 216 determines that the plurality of brokers are healthy in response to determining that each of the plurality of brokers have a broker score which is above a predetermined broker score threshold (i.e., YES at step 1105). In this scenario, the operations move to step 1110. In embodiments and as described with FIG. 2, the partition leader adjustment module 216 determines that at least one of the plurality of brokers is not healthy in response to determining that at least one of the plurality of brokers has a broker score which is equal to or below the predetermined broker score threshold (i.e., NO at step 1105). In this scenario, the operations go to step 1125.

At step 1110, the system starts, at the partition leader adjustment module 216, the previous partition leader as a follower. At step 1115, the system synchronizes, at the partition leader adjustment module 216, messages with a new partition leader. At step 1120, the system switches, at the partition leader adjustment module 216, the partition leader to the previous partition leader. At step 1125, the system performs, at the data collection module 210, data monitoring of the real-time data.

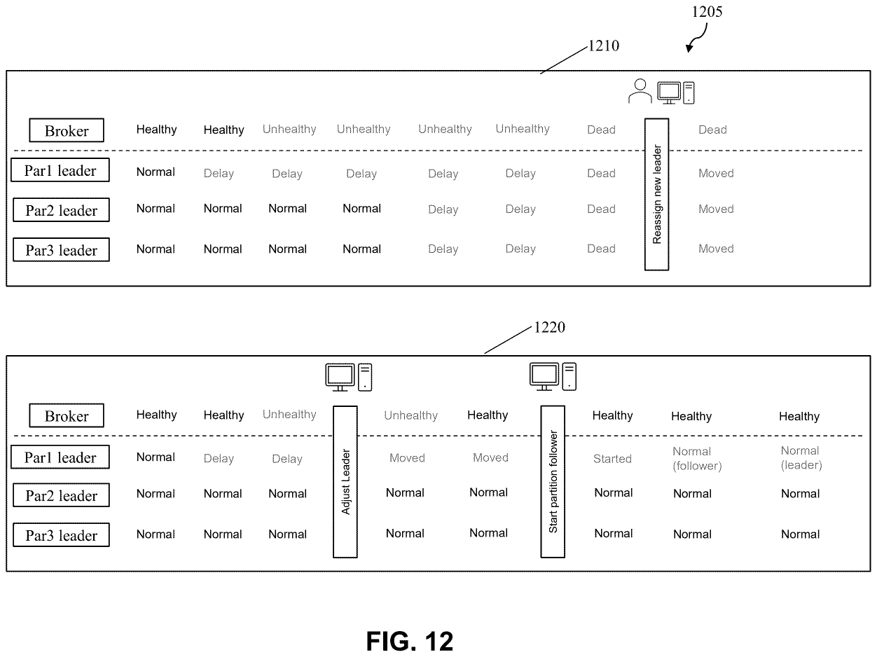

FIG. 12 shows a block diagram of the exemplary environment in accordance with aspects of the present invention. In the block diagram 1205, the conventional system 1210 is shown in which the leader (i.e., par1 leader) has a continuous delay which cascades to delay par2 leader and par3 leader. Eventually, in the conventional system 1210, the par1 leader, the par2 leader, and the par3 leader all have a dead state. In the conventional system 1210, a partition leader is re-assigned only when par1 leader, par2 leader, and par3 leader are all dead. In contrast, in aspects of the present invention, the block diagram 1220 includes a leader (i.e., par1 leader) which has a delay for two cycles which causes the broker to be unhealthy. At this time in the block diagram 1220, the partition leader adjustment 216 adjusts the partition leader to a healthy broker and then starts the previous partition leader as a follower in response to determining that the broker is healthy again. After the previous partition as the follower is in a healthy state in the block diagram 1220, the partition leader adjustment 216 switches the partition leader to the previous partition leader. Accordingly, embodiments of the present invention are able to dynamically adjust a partition leader which reduces a data latency that occurs in conventional systems.

In embodiments, a service provider could offer to perform the processes described herein. In this case, the service provider can create, maintain, deploy, support, etc., the computer infrastructure that performs the process steps of the present invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the present invention provides a computer-implemented method, via a network. In this case, a computer infrastructure, such as computer 101 of FIG. 1, can be provided and one or more systems for performing the processes of the present invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the present invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
collecting, by a processor set, real-time data of a broker which manages data flow in a cluster;
predicting, by the processor set, a broker score based on a trained broker bottleneck prediction model, the trained broker bottleneck prediction model is trained with the real-time data of the broker;
predicting, by the processor set, a final topic partition health prediction based on a trained topic partition model, the trained topic partition model is trained with the predicted broker score;
determining, by the processor set, that a partition leader is changing based on the predicted final topic partition health prediction being abnormal; and
adjusting, by the processor set, the partition leader to a healthy broker based on the determination.

2. The computer-implemented method of claim 1, wherein the real-time data comprises at least one of system layer data and cluster layer data.

3. The computer-implemented method of claim 2, wherein the system layer data comprises broker input/output throughput and central processing unit (CPU) usage, and the cluster layer data comprises a partition number, definition rules for a partition for every topic, a consumer number, and a delay.

4. The computer-implemented method of claim 1, wherein the trained broker bottleneck prediction model is further trained using historical data of the broker and the real-time data of the broker by utilizing a first machine learning (ML) algorithm.

5. The computer-implemented method of claim 4, wherein the first ML algorithm comprises a long short-term memory (LSTM) algorithm.

6. The computer-implemented method of claim 1, wherein the trained topic partition model is further trained using a delay for a partition, message count, and message type by utilizing a second machine learning (ML) algorithm.

7. The computer-implemented method of claim 6, wherein the second ML algorithm comprises a long short-term memory (LSTM) algorithm.

8. The computer-implemented method of claim 6, further comprising scanning, by the processor set, a plurality of brokers to determine the healthy broker.

9. The computer-implemented method of claim 8, wherein the healthy broker has a highest broker score in the plurality of brokers.

10. The computer-implemented method of claim 1, further comprising performing, by the processor set, a high water mark (HWM) policy on a plurality of partitions to determine an offset of a last message that has been successfully replaced to all replicas of a partition.

11. The computer-implemented method of claim 1, further comprising starting, by the processor set, a previous partition leader as a follower.

12. The computer-implemented method of claim 11, further comprising switching, by the processor set, the partition leader to the previous partition leader.

13. A computer program product comprising:
one or more computer readable storage media; and
program instructions stored on the one or more computer readable storage media to perform operations comprising:
collecting real-time data of a broker which manages data flow in a cluster;
predicting a broker score based on a trained broker bottleneck prediction model, the trained broker bottleneck prediction model is trained with the real-time data of the broker;
predicting a final topic partition health prediction based on a trained topic partition model, the trained topic partition model is trained with the predicted broker score;
determining that a partition leader is changing based on the predicted final topic partition health prediction being abnormal; and
adjusting the partition leader to a healthy broker based on the determination.

14. The computer program product of claim 13, wherein the real-time data comprises at least one of system layer data and cluster layer data.

15. The computer program product of claim 14, wherein the system layer data comprises broker input/output throughput and central processing unit (CPU) usage, and the cluster layer data comprises a partition number, definition rules for a partition for every topic, a consumer number, and a delay.

16. The computer program product of claim 13, wherein the trained broker bottleneck prediction model is further trained using historical data of the broker and the real-time data of the broker by utilizing a first machine learning (ML) algorithm.

17. The computer program product of claim 16, wherein the first ML algorithm comprises a long short-term memory (LSTM) algorithm.

18. The computer program product of claim 13, wherein the trained topic partition model is further trained using a delay for a partition, message count, and message type by utilizing a second machine learning (ML) algorithm.

19. The computer program product of claim 18, wherein the second ML algorithm comprises a long short-term memory (LSTM) algorithm.

20. A system comprising:
a processor set;
one or more computer readable storage media; and
program instructions stored on the one or more computer readable storage media to cause the processor set to perform operations comprising:
collecting a real-time data of a broker which manages data flow in a cluster;
predicting a broker score based on a trained broker bottleneck prediction model, the trained broker bottleneck prediction model is trained with the real-time data of the broker;
predicting a final topic partition health prediction based on a trained topic partition model, the trained topic partition model is trained with the predicted broker score;
determining that a partition leader is changing based on the predicted final topic partition health prediction being abnormal;
scanning, by the processor set, a plurality of brokers to determine a healthy broker;
adjusting the partition leader to the healthy broker based on the determination; and
starting a previous partition leader as a follower.
